(19) United States
(12) Patent Application Publication
(10) Pub. No.: US 2024/0089135 A1
(43) Pub. Date: Mar. 14, 2024

(54) DYNAMIC AUDIO FEEDS FOR WEARABLE AUDIO DEVICES IN AUDIOVISUAL CONFERENCES

(71) Applicant: Apple Inc., Cupertino, CA (US)

(72) Inventor: Daniel W. Jarvis, Sunnyvale, CA (US)

(21) Appl. No.: 17/944,885

(22) Filed: Sep. 14, 2022

(51) Int. Cl. H04L 12/18; G10L 25/78; H04N 7/15; H04S 7/00

(52) U.S. Cl. CPC H04L 12/1822; G10L 25/78; H04N 7/15; H04S 7/303

(57) ABSTRACT

A method may include, at an audiovisual conferencing system receiving first audio information captured by a first audio device associated with a first local participant of a group of local participants, receiving second audio information captured by a second audio device associated with a second local participant, and receiving third audio information from a remote participant. The method may further include, in accordance with a determination that the first local participant satisfies a location criteria, providing a first aggregate audio feed to the first audio device of the first local participant that includes the third audio information from the remote participant and omits the second audio information from the second local participant, and providing a second aggregate audio feed to the second audio device of the second local participant that includes the third audio information from the remote participant and omits the first audio information from the first local participant.

### FIELD

The subject matter of this disclosure relates generally to audiovisual conferencing systems, and more particularly, to dynamic audio feeds for audio devices being used in audiovisual conferences.

### BACKGROUND

Modern communications systems facilitate a wide range of ways to connect and interact with others. For example, electronic devices such as mobile phones and personal computers include microphones, speakers, and video cameras, and allow users to communicate with one another via voice and video communications. In many cases, multiple participants may join in a communication session, sometimes known as a conference call or a video conference. In the case of a video conference, both audio and video feeds from each participant may be provided to each other participant so that each participant can hear, see, and interact with the others.

### SUMMARY

A method may include, at an audiovisual conferencing system receiving first audio information captured by a first audio device associated with a first local participant of a group of local participants sharing a physical space during an audiovisual conference, receiving second audio information captured by a second audio device associated with a second local participant of the group of local participants, and receiving third audio information from a remote participant. The method may further include, in accordance with a determination that the first local participant satisfies a location criteria during the audiovisual conference, providing a first aggregate audio feed to the first audio device of the first local participant that includes the third audio information from the remote participant and omits the second audio information from the second local participant, and providing a second aggregate audio feed to the second audio device of the second local participant that includes the third audio information from the remote participant and omits the first audio information from the first local participant.

The method may further include, during the audiovisual conference, determining that the first local participant is speaking based at least in part on the received first audio information, and in accordance with the determination that the first local participant is speaking, providing an indication, in a graphical user interface of the remote participant, that the first local participant in the shared physical space is speaking.

The first audio device may be configured to send the first audio information to a first electronic device associated with the first local participant, the second audio device may be configured to send the second audio information to a second electronic device associated with the second local participant, the first electronic device may be configured to determine first location information of the first local participant, the second electronic device may be configured to determine second location information of the second local participant, and the audiovisual conferencing system may be configured to determine whether the first local participant satisfies a location criteria based at least in part on the first location information and the second location information.

The first audio device may be configured to send the first audio information to a first electronic device associated with the first local participant, the second audio device may be configured to send the second audio information to a second electronic device associated with the second local participant, the first electronic device may be configured to detect a distance between the first electronic device and the second electronic device, and the location criteria may be satisfied when the first electronic device may be within a threshold distance of the second electronic device.

The first audio device may include a speaker and a microphone, and the first audio device may be configured to be positioned at least partially in an ear of the first local participant and may be configured to capture, with the microphone, first audio from the first local participant and second audio from the second local participant, and may be configured to cause the speaker to output the second audio to the first local participant.

The microphone may be a first microphone, the speaker may be a first speaker, the second audio device may include a second speaker and a second microphone, and the second wearable audio device may be configured to be positioned at least partially in an ear of the second local participant and may be configured to capture, with the second microphone, the second audio from the second local participant and the first audio from the first local participant. The second audio device may be configured to cause the second speaker to output the first audio to the second local participant.

The first audio device may include a first speaker and a first microphone system including a first array of microphones and configured to preferentially capture sound from the first local participant, and the second audio device may include a second speaker and a second microphone system including a second array of microphones and configured to preferentially capture sound from the second local participant. The first microphone system may perform a beamforming operation to preferentially capture sound from the first local participant.

A method may include, at an audiovisual conferencing system configured to host an audiovisual conference for a group of participants, the group of participants including a group of local participants sharing a physical space and a group of remote participants remote from the local participants receiving respective audio information from each respective local participant of at least a subset of the group of local participants, the respective audio information captured by respective wearable audio devices associated with the respective local participants, receiving respective audio information from each respective remote participant of the group of remote participants, providing an aggregate local audio feed to a wearable audio device of a local participant, the aggregate local audio feed including the audio information from each remote participant and excluding the audio information from each local participant, and providing an aggregate remote audio feed to a remote participant, the aggregate remote audio feed including the audio information from each remote participant other than the remote participant and including the audio information from each local participant.

The aggregate local audio feed may be a first aggregate local audio feed, the method may further include providing a second aggregate local audio feed to a conference audio device positioned in the physical space and including a speaker and a microphone, and the second local aggregate local audio feed may include the audio information from each remote participant and exclude the audio information from each local participant. The subset of the group of local participants may be a first subset of the group of local participants, and the microphone of the conference audio device captures audio from a second subset of the group of local participants. The microphone may be a first microphone, the speaker may be a first speaker, and a wearable audio device of a local participant may include a second microphone configured to capture audio from the local participant and a second speaker configured to output the first aggregate local audio feed to the local participant.

The method may further include determining an identifier associated with a local participant of the subset of the group of local participants, and in accordance with a determination that the local participant is speaking, causing an electronic device associated with a remote participant to display, in an audiovisual conferencing user interface, the identifier of the local participant.

The electronic device may be a first electronic device and the local participant may be associated with a second electronic device. The second electronic device may receive audio information from a wearable audio device associated with the local participant, and determining the identifier associated with the local participant may include determining a user account associated with an audiovisual conferencing application executed by the second electronic device.

A method may include, at an audiovisual conferencing system for a group of participants in an audiovisual conference, wherein the group of participants includes at least one remote participant identifying a set of local participants of the group of participants who satisfy a location criteria with respect to each other, each respective local participant associated with a respective audio device, providing, to the respective audio devices of the identified local participants, an aggregate local audio feed including audio information received from the remote participant, and providing, to the remote participant, an aggregate remote audio feed including audio information received from each local participant. Identifying the set of local participants who satisfy the location criteria with respect to each other may include determining that a first local participant satisfies the location criteria with respect to a second local participant.

Determining that the first local participant satisfies the location criteria with respect to the second local participant may include determining that the first local participant may be in a same room as the second local participant.

Determining that the first local participant satisfies the location criteria with respect to the second local participant may include determining that a first audio device associated with the first local participant detects audio also detected by a second audio device associated with the second local participant.

The method may further include providing, to a first audio device associated with a first local participant of the set of local participants, audio from a second local participant captured by a microphone of the first audio device. The method may further include providing, to a second audio device associated with a second local participant of the set of local participants, audio from the first local participant captured by a microphone of the second audio device.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 depicts an example networked environment instantiating an audiovisual conferencing system;

FIG. 2 depicts a graphical user interface of an audiovisual conferencing system;

FIGS. 3A-3B depict example aggregate audio feeds for an audiovisual conferencing system;

FIG. 4 depicts an example shared physical space with multiple participants in an audiovisual conference;

FIG. 5 depicts another example shared physical space with multiple participants in an audiovisual conference;

FIG. 6 depicts another example shared physical space with multiple participants in an audiovisual conference;

FIG. 7 depicts another example shared physical space with multiple participants in an audiovisual conference;

FIG. 8 is a flow chart of an example method for providing aggregate audio feeds to participants in an audiovisual conference;

FIG. 9 depicts a schematic diagram of an example wearable audio device; and

FIG. 10 depicts a schematic diagram of an example electronic device.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Audiovisual conferencing systems are increasingly used to allow participants in multiple different locations to communicate with one another. Audiovisual conferencing systems may provide audio (e.g., voice) and/or video communications between participants. Audiovisual conferencing systems may be accessed through personal electronic devices, such as computers (e.g., laptop computers, desktop computers), tablet computers, mobile phones, dedicated audiovisual conferencing hardware (e.g., speakerphones, videophones, cameras, etc.). The personal electronic devices may display a graphical user interface to the participants to provide audio and/or video content and otherwise facilitate user interaction with the audiovisual conferencing system.

In some cases, the graphical user interface displays video feeds of all or a subset of the participants in an audiovisual (“AV”) conference. In some cases, the graphical user interface provides an indication of which participants are speaking at a given time. For example, the video feed of a participant who is actively speaking may appear with a highlighted border or may be displayed in a prominent position in the graphical user interface. In some cases, their name or username may also be displayed. In this way, the participants can easily determine who is speaking at a given time. This may be especially beneficial in AV conferences with many participants and/or in cases where a given participant may be unfamiliar with other participants.

In some cases, such as in workforces that include both remote and local employees, some participants of an AV conference may join the AV conference from the same room. For example, those employees who are working from an office may join an AV conference in a conference room, while remote employees join the AV conference from their homes or other remote locations. Conventionally, the conference room may have AV conferencing hardware, such as a speakerphone and a camera to capture audio and video content from all of the participants in the conference room. For remote participants, the conference room may be presented as a single video and audio feed, such that when anyone in the conference room speaks, the remote participant's user interface shows that the conference room is actively providing audio, without differentiating between the individual participants in the conference room. Thus, it may be difficult for a user to determine which participant in the conference room is speaking.

As described herein, participants in a shared space (e.g., in a conference room) may use wearable electronic devices, such as ear-worn headphones (e.g., earbuds), to receive audio from and provide audio to an AV conference. Moreover, participants in the shared space may join the AV conference via a personal electronic device, such as a mobile phone, laptop computer, or tablet computer, using a unique account or login. As such, the AV conferencing system can associate a name or unique identifier with each local participant.

However, when multiple participants use wearable audio devices when sharing a common space for an AV conference, they may experience audio issues. For example, they will both hear other local participants speaking (due to being in the same room) and will also receive those participants' voices replayed to them via their wearable audio device. This can be confusing and distracting, and generally presents an unacceptable AV conference experience.

Accordingly, as described herein, an AV conferencing system may be provided that determines whether certain participants in an AV conference are sharing a common space, and provide a customized audio feed to the local participants. For example, the AV conferencing system may generate an aggregate audio feed that is provided to each remote participant, where the aggregate audio feed includes audio information from each participant in the AV conference. For the participants sharing a same space, however, the AV conferencing system may provide an audio feed that includes audio information from each remote participant, but excludes the audio feeds from the other local participants. Thus, the local participants only hear the other local participants directly (e.g., not through the AV conferencing system), yet still hear the remote participants via their wearable devices (e.g., earbuds). Thus, the AV conferencing system described herein provides improved AV conferencing functionality to remote users, as individuals may be uniquely identified despite sharing a common space, without detracting from the experience of the local participants.

As used herein, an aggregate audio feed refers to an audio feed that is provided to a participant as part of an AV conference. The aggregate audio feed is configured to provide audio information from other participants in the AV conference. The aggregate audio feed may be understood as a set of audio channels or paths from other participants, and the aggregate audio feed may exist even when only one (or no) participants are actually outputting audio. (E.g., an aggregate audio feed may include audio from one active speaker and one or more muted or silent participants.)

As used herein, a local participant refers to a participant in an AV conference who is sharing a physical space with one or more other participants in the AV conference. As used herein, a remote participant refers to a participant in an AV conference who is not sharing a physical space with other participants in the AV conference. Thus, the terms local and remote do not necessarily imply any absolute geographical location. For example, in some cases, a remote participant may be in an office during an AV conference while multiple local participants are in a neighboring conference room in the same building. As another example, a remote participant may be in a home office during an AV conference, while multiple local participants are in sharing a single office in a remote office building.

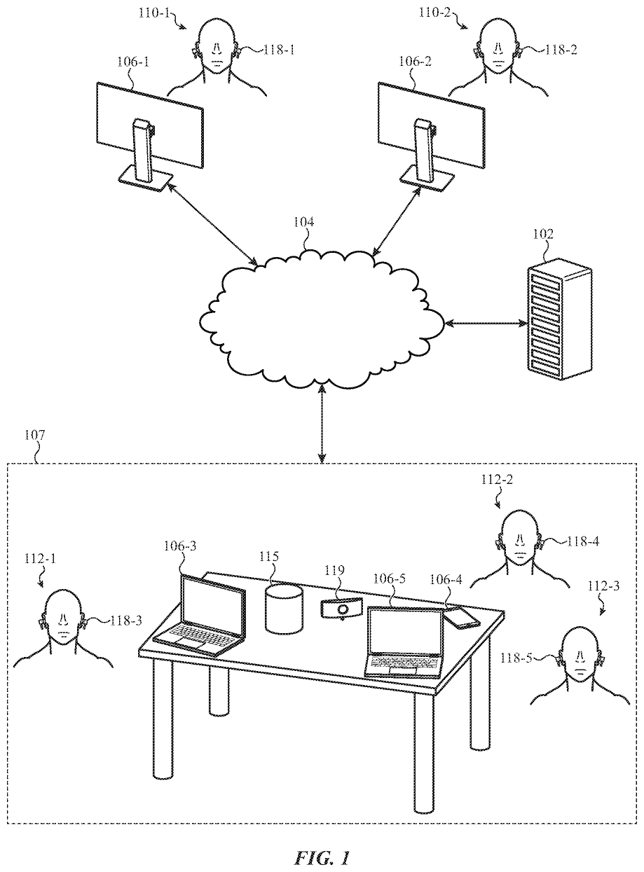

FIG. 1 illustrates an example networked environment in which an AV conferencing system may be instantiated. The AV conferencing system may host AV conferences, which may include receiving audio and/or video information from participants, providing audio and/or video information to participants, determining what audio information to include the audio feeds provided to each participant, generating different aggregate audio feeds for different participants, and otherwise facilitating AV conferences and AV conference functionality for the participants of an AV conference.

As shown in FIG. 1, an AV conference may include one or more remote participants 110 (e.g., 110-1, 110-2) and one or more local participants 112 (e.g., 112-1, 112-2, 112-3). The local participants 112 may be sharing a physical space 107, such as a common room, conference room, office, or the like. The shared physical space 107 may be any space in which the local participants 112 are generally within a speaking distance (e.g., so that they can hear each other speaking in that space).

Each user may be associated with an electronic device 106 (e.g., 106-1-106-5). The electronic devices 106 may be any device that facilitates access to an AV conference, such as a tablet computer, desktop computer, laptop computer, mobile phone, dedicated AV conferencing hardware, or the like. The electronic devices 106 may include microphones, video or still cameras, and/or other audiovisual components to capture audio and video information from a participant, and to provide audio and video information to a participant. The electronic devices 106 may also generate and display graphical user interfaces to the participants. The graphical user interfaces may display video feeds of the other participants in an AV conference, and may allow the user to control various aspects of the AV conference and/or their participation in the AV conference (e.g., activating/deactivating video capture, muting audio, joining or disconnecting from AV conferences, etc.).

The participants may also use wearable audio devices 118 (e.g., 118-1-118-5), or other audio devices, to provide and/or receive audio information for an AV conference. The wearable audio devices 118 may include one or more microphones and one or more speakers, and may communicate (e.g., via wired or wireless communications) to an electronic device 106 associated with that participant. The wearable audio devices 118 may capture audio information from a participant, and transmit the captured audio information to an electronic device 106 associated with the participant. The electronic device 106 may then transmit the captured audio information to another device (e.g., an AV conferencing system server 102) for inclusion in aggregate audio feeds that are distributed to the other participants. The wearable audio devices 118 may process the received audio information prior to transmitting it to an electronic device 106. In some cases, the wearable audio device 118 perform analog-to-digital conversion on the captured audio information. Other processing operations may include noise cancellation, beamforming, filtering, or the like.

The wearable audio devices 118 may be positionable at least partially in an ear of a participant. For example, the wearable audio devices 118 may be or resemble earbuds. In other cases, the wearable audio devices 118 may be over-the-ear or on-the-ear headphones, or other types of wearable audio devices. In some cases, the wearable audio devices 118 are configured for audio capture only (e.g., they may lack speakers or otherwise not be configured to output audio to a participant), or for audio output only (e.g., they may lack microphones or otherwise not be configured to capture audio of a participant). In some cases, other types of audio devices may be used instead of or in addition to wearable audio devices. For example, a mobile phone or laptop computer may provide highly directional audio capture (and optionally highly directional audio output), such that individual audio feeds may be captured from local participants even without having to wear a device. Other types of audio devices (wearable and non-wearable) are also contemplated.

The shared physical space 107 may include a conference audio device 115 and a conference camera 119. The conference audio device 115 may include one or more speakers and one or more microphones and may be used to capture audio and present audio for local participants who do not have wearable audio devices (and/or to provide other functions). The conference camera 119 may capture video information of the shared physical space 107 for display to other participants.

The AV conferencing system may be instantiated by one or more computing resources. The computing resources may include one or more servers (e.g., the server 102), data stores (e.g., databases), cloud-based computing resources, programs, systems, subsystems, or other components that provide functionality described herein. The computing resources may also include client devices, such as the electronic devices 106. The computing resources may communicate over a network 104 to provide the services and/or functions of the AV conferencing system as described herein.

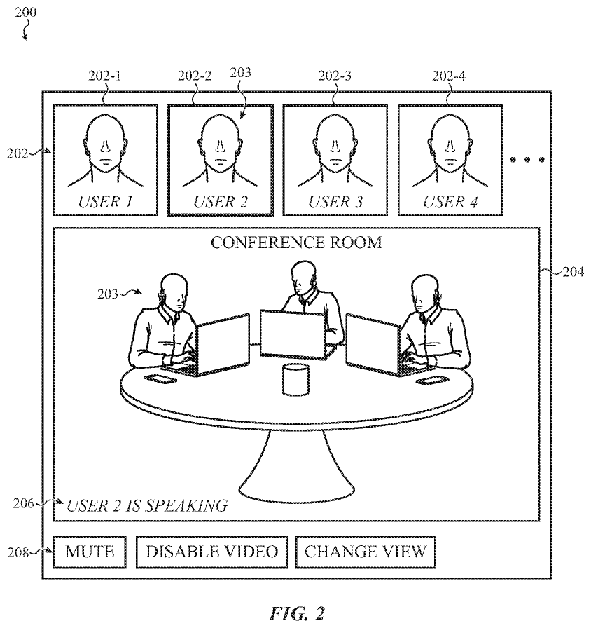

FIG. 1 illustrates an AV conference that includes remote participants, and local participants who are sharing a physical space during an AV conference. As described above, when the local participants use wearable audio devices (which can be uniquely associated with the wearer's account or name) to capture their audio information, the AV conferencing system may display an identifier of or otherwise uniquely identify the local participants to the remote users (and optionally all users), as described herein with respect to FIG. 2.

FIG. 2 is an example graphical user interface 200 that may be displayed to a participant during an AV conference. The graphical user interface 200 (or simply interface 200) may include individual video feed windows 202 (e.g., 202-1-202-4), showing the video feed of other participants. The graphical user interface 200 may also include a main feed window 204, which may be larger and/or more prominently displayed than the individual video feed windows 202. The graphical user interface 200 may also include controls 208 for controlling aspects of the AV conference and/or a participant's device. For example, the controls 208 may allow a user of the graphical user interface to control their audio settings (e.g., mute their microphone, change an audio source, etc.), control their video settings (e.g., enable or disable their video camera), control the arrangement of video feed windows in the graphical user interface, and so forth. Other controls may be included instead of or in addition to those shown in FIG. 2.

The video feed windows 202, 204 may display video feeds from electronic devices associated with individual participants, and/or from shared physical spaces (e.g., conference rooms). For example, each participant may connect to an AV conference via a device such as a laptop computer, tablet computer, desktop computer, or the like, which may include a camera that captures video of the participant. The captured video of the participants (from their respective electronic devices) may be displayed in the graphical user interface of the participants of the AV conference. Video feeds from shared physical spaces may also be displayed. In such cases, the video feed may include all or a subset of the participants in the shared space. In some cases, a conference room or shared-space video camera may automatically zoom in a participant when that participant is determined to be speaking.

The particular arrangement and content of the video feed windows 202, 204 shown in FIG. 2 is merely an example, and the graphical user interface may have different configurations than that shown. For example, the graphical user interface 200 may display a grid of individual video feed windows 202 without a main feed window 204. Alternatively, the graphical user interface 200 may include only a single window (which may automatically display a participant who is currently speaking). The particular arrangement of video feed windows and the video feeds associated with those windows (as well as settings related to how the video feed windows may change during an AV conference) may be selectable by a participant or administrator of the AV conference.

As described herein, one advantage of the AV conferencing system as described herein is that participants in a shared physical space may each be associated with their own audio feed or channel (and optionally their own video feed as well), such that the graphical user interface of the AV conferencing system can indicate which specific participant in a shared space is speaking. FIG. 2 illustrates example ways in which the graphical user interface 200 may indicate which participant in a group of participants in a shared physical space is speaking. For example, FIG. 2 illustrates an example AV conference in which a group of local participants (e.g., users 1-3) are located in a conference room, and at least one remote user (e.g., user 4) is located remotely from the conference room.

As illustrated in FIG. 2, each local participant is associated with a wearable audio device (e.g., a pair of earbuds with speakers and one or more microphones) and an electronic device (e.g., a laptop computer). Accordingly, audio information (and optionally video information) may be separately captured for each local participant.

When the AV conferencing system detects that a local participant is speaking, the AV conferencing system may cause graphical user interfaces of the remote participants to indicate which particular local participant is speaking. This is possible because the audio information (and optionally video information) from the local participants is captured by one or more devices that are uniquely associated with an individual local participant. For example, as described above, the audio information from respective local participants may be captured by respective wearable audio devices worn by the local participants, and video information for respective local participants may be captured by electronic devices individually associated with the respective local participants. Thus, the AV conferencing system can uniquely identify individual speakers even if they are in a shared physical space with multiple other participants.

The graphical user interface may indicate the active speaker in various ways. For example, a video feed window of the participant who is speaking may be emphasized or otherwise displayed in a visually distinctive manner. FIG. 2 illustrates the individual video feed window 202-2 displayed with a bold border, indicating that the participant of that video feed (e.g., User 2, 203) is actively speaking. Other ways of visually distinguishing a video feed window are also contemplated. For example, the border of the video feed window may have a particular color, or the video feed window may change size and/or location in the graphical user interface, or a graphic (e.g., a star, image of a loudspeaker, animation, etc.) may be shown near or in the video feed window. In some cases, a username of the speaking participant may be displayed in the video feed window and/or in a different location.

In cases where local participants in a shared physical space have dedicated cameras (e.g., via the laptop, tablet, phone, or other computing device they are using to connect to the AV conference), those participants may be shown in an individual video feed window. In some cases, a shared physical space may also have a camera that captures video of multiple participants. This camera feed may be displayed in a graphical user interface for the AV conference instead of or in addition to the individual video feeds of the local participants. For example, FIG. 2 illustrates a “conference room” video feed shown in the main feed window 204. The conference room video feed may display video of multiple local participants, such as User 1, User 2, and User 3. While FIG. 2 shows the conference room video feed in the main feed window, this is merely an example, and different video feeds may be shown in different locations, as described above.

In cases where a shared physical space with multiple local participants is displayed in a video feed, the AV conferencing system may still indicate which local participant is speaking. For example, as shown in FIG. 2, the conference room with Users 1-3 is shown in the main feed window 204. When the AV conferencing system determines that a particular local participant in the shared physical space is speaking (e.g., User 2, 203), the graphical user interface may display an identifier 206 of the speaker (e.g., “User 2 is speaking”). The identifier may be shown in or near the video feed window of the shared physical space to allow viewers to quickly determine both who is speaking, and where they the speaker is located (e.g., which shared physical space they are in).

In cases where a shared physical space has a camera and the local participants in the shared physical space also have their own cameras, video feeds from both the shared space and from the individual local participants may be displayed in the graphical user interface, as shown in FIG. 2.

As described herein, in order for local participants to effectively share a physical space while participating in an AV conference, the AV conferencing system described herein generates different aggregate audio feeds for different participants depending (at least in part) on whether the receiving participant is sharing a common physical space with other participants. Thus, for example, the aggregate audio feed for a participant sharing a physical space during an AV conference (e.g., a local participant) may include audio information from remote participants but exclude audio information from other local participants in the same shared physical space. Aggregate audio feeds for remote participants, by contrast, include audio information from both local and remote participants.

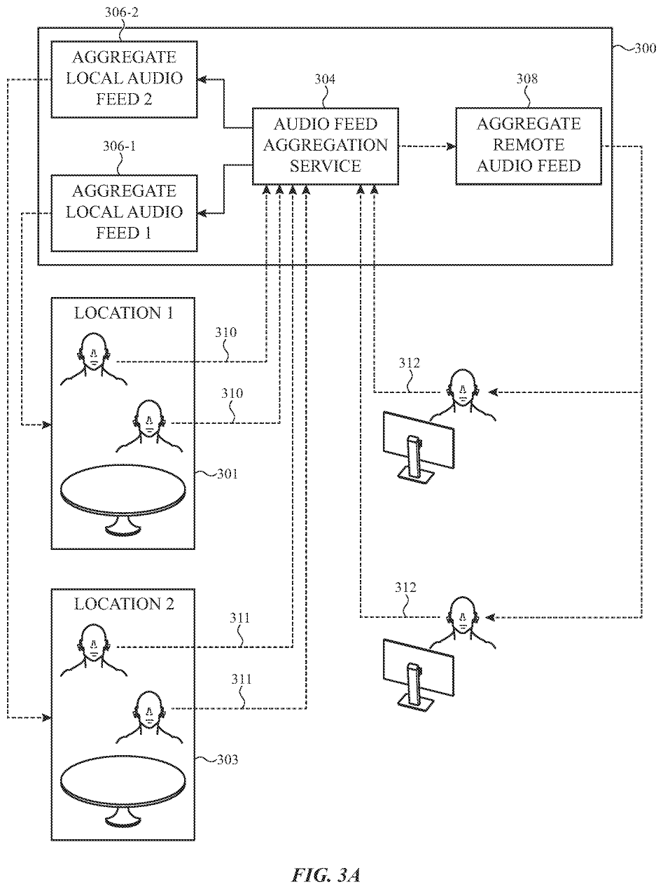

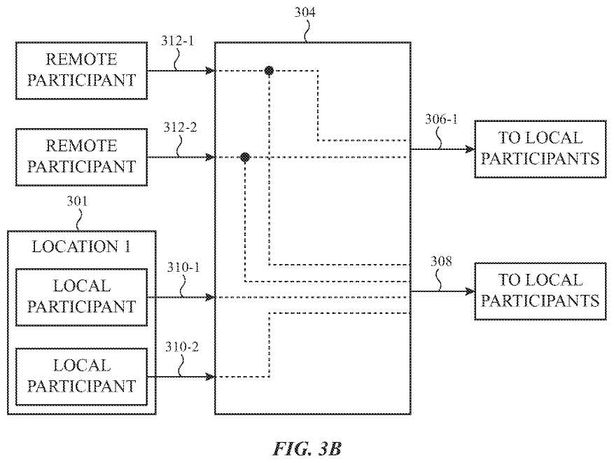

FIG. 3A illustrates how an AV conferencing system may create and distribute aggregate audio feeds to participants of an AV conference. In particular, FIG. 3A illustrates an AV conferencing system 300 (or portion thereof) that receives audio information from multiple participants, generates appropriate aggregate audio feeds for the participants, and provides the aggregate audio feeds to the participants. The AV conferencing system 300 may also receive video information from and provide video feeds to the various participants.

The AV conferencing system 300 may include an audio feed aggregation service 304 that receives audio information 310, 311 from participants sharing a physical space (e.g., local participants), and audio information 312 from participants who are not sharing a physical space with other participants (e.g., remote participants). The audio information 310, 311, 312 may be captured by one or more electronic devices associated with the participant. In the case of local participants, the audio information 310, 311 may be captured by wearable audio devices being worn by those participants. For example, wearable audio devices may be or may include ear-mounted components that are positioned at least partially in the ear(s) of the participant (e.g., earbuds). The wearable audio devices may include or be part of a microphone system (e.g., including one or multiple microphones and/or other audio transducers as well as associated circuitry), and may perform a beamforming operation to preferentially capture sound from the wearer. The wearable audio devices may also perform other audio operations, such as noise cancellation, noise suppression, filtering, automatic muting, or the like. In some cases, the wearable audio devices may communicatively couple to another electronic device (e.g., a mobile phone, laptop or tablet computer, or the like), and beamforming and other audio operations may be performed by the wearable audio devices in conjunction with the other electronic devices.

The audio information 312 from the remote participants may be captured by one or more electronic devices associated with the remote participants. In some cases, the audio information may be captured by wearable audio devices (e.g., earbuds, as described herein). In other cases, the audio information may be captured by a microphone system of a mobile phone, laptop, tablet, or desktop computer, speaker phone system, or the like. The audio devices used to capture the information 312 from the remote participants may perform beamforming and/or other audio operations, as described with respect to the local participants. Because remote participants are not sharing a physical space with other AV conference participants, however, beamforming and other operations to preferentially capture sound from single individuals may not be required. For example, capturing audio information preferentially from a local participant may facilitate identification of the particular speaker in a shared space (e.g., so that a microphone system associated with a first local participant does not capture the voice of a second local participant. By contrast, any audio captured by a microphone system being used by a remote participant may be considered to originate from that participant (or at least that participant's environment), and thus the AV conferencing system may operate effectively without beamforming or other preferential audio capture processes for remote participants.

As shown in FIG. 3A, the audio feed aggregation service 304 may receive audio information 310, 311, 312 from the local and remote participants. The audio information 310, 311, 312 may be sent to the audio feed aggregation service 304 from the electronic devices that the participants are using to connect to the AV conference. The audio information 310, 311, 312 may be sent as using streaming audio protocols (e.g., real time streaming protocol (RTSP), real time transport protocol (RTP), or the like), analog audio signals, or other suitable protocol or technique. The audio information 310, 311, 312 may be sent via an electronic device that the participant is using to connect to the AV conference, and may be associated with a particular participant. For example, each stream or channel of audio information may be uniquely associated with a name, username, account, invitation, or other data or information. The AV conferencing system may use that information to indicate to the participants who is speaking at a given time.

The audio feed aggregation service 304 may generate one or more aggregate audio feeds to provide to the participants of the AV conference. For the remote participants, the audio feed aggregation service 304 may generate an aggregate remote audio feed 308, which includes audio of each local participant and each remote participant, except for the remote participant receiving the aggregate remote audio feed. The aggregate remote audio feeds 308 may be provided to the remote participants. Accordingly, the remote participants can hear audio from each AV conference participant. (For both remote and local participants, a participant's own audio information may be excluded from the audio feed that they receive to avoid an “echo” or other distracting and/or confusing audio phenomenon.)

For the local participants, the audio feed aggregation service 304 may generate aggregate local audio feeds 306. Each local audio feed may be unique to a shared location. For example, the first aggregate local audio feed 306-1 is unique to a first shared physical space 301 (location 1), and the second aggregate local audio feed 306-2 is unique to a second shared physical space 303 (location 2). For example, the first aggregate local audio feed 306-1 to the first shared physical space 301 includes audio information from the remote participants (e.g., audio information 312) and from other local participants who are sharing a different physical space (e.g., audio information 311 from location 2), but omits audio information from other local participants sharing the same physical space (e.g., audio information 310 from location 1). More particularly, the local participants in the first shared physical space 301, will hear each other directly and thus do not need (and would be distracted by) an audio feed that included the voices of the other local participants in that shared physical space. Similarly, the second aggregate local audio feed 306-2 includes audio information from the remote participants (e.g., audio information 312) and from other local participants who are sharing a different physical space (e.g., audio information 310 from location 1), but omits audio information from other local participants sharing the same physical space (e.g., audio information 311 from location 2).

FIG. 3B further illustrates how aggregate audio feeds may be generated and what audio information they may include. For example, audio information 312-1 from a first remote participant and audio information 312-2 from a second remote participant are included in the aggregate local audio feed 306-1 that is provided to the local participants, while the audio information 310-1 and 310-2 from the local participants is not included in the aggregate local audio feed 306-1. Audio information 310 from the local participants and audio information 312 from the remote participants are included in the aggregate remote audio feed 308 that is provided to the remote participants. (As noted above, a participant's own audio information is omitted from the aggregate audio feed that is provided to that participant.)

Whether participants are sharing a physical space may be determined in various ways. For example, one or more electronic devices associated with AV conference participants may determine location information of users and/or the proximity to other users. The location information and/or proximity information may be used to determine whether a participant satisfies a location criteria indicating that the participant is sharing a physical space with one or more other participants.

Location and/or proximity information for a participant may be determined in various ways. For example, an electronic device associated with a participant (e.g., a mobile phone, computer, wearable electronic device, wearable audio device, wirelessly locatable tag, etc.) may be configured to determine a geographical location of that participant. The geographical location may be determined using GPS positioning systems, inertial measurement units, wireless triangulation, and/or other location-determining systems and/or techniques. The AV conferencing system may compare the geographical location of the participants and determine which participants satisfy the location criteria based on the geographical locations. For example, if the geographical locations of two participants indicate that they are within a threshold distance of one another (e.g., about 5 feet, about 10 feet, about 20 feet, about 50 feet, or another suitable threshold distance), the AV conferencing system may determine that those participants are likely sharing a physical space, and may generate the aggregate local audio feeds for those participants accordingly. In some cases, the AV conferencing system may use map and/or building information to determine whether the location criteria is met. For example, the AV conferencing system may determine, using map and/or building information and the geographical location of participants in an AV conference, whether any participants are sharing a physical space. This may help avoid false-positive determinations of proximity, such as may occur when two participants are joining an AV conference from adjacent but separate offices.

In some cases, electronic devices are configured to detect distances between other electronic devices to determine proximity. For example, electronic devices may include antennas (e.g., ultrawideband antennas or other types of antennas) that use time-of-flight techniques to determine a proximity to other electronic devices. Accordingly, the AV conferencing system may determine whether devices (and thus their users) satisfy a location criteria with respect to other devices. For example, if the proximity of the devices of two participants indicate that they are within a threshold distance of one another (e.g., about 5 feet, about 10 feet, about 20 feet, about 50 feet, or another suitable threshold distance), the AV conferencing system may determine that those participants are likely sharing a physical space, and may generate the aggregate local audio feeds for those participants accordingly.

In some cases, the AV conferencing system may perform additional or alternative operations to determine if participants are sharing a physical space. For example, one or more devices associated with AV conference participants may output an audio signal (e.g., a tone, audible pattern, song, encoded audio signal, etc.). If other devices detect the audio signal, the AV conferencing system may determine that those devices are likely sharing a physical space or are otherwise in close enough proximity that the participants can likely hear one another locally. Other techniques are also contemplated.

In some cases, participants can manually select whether they are sharing a local space with other participants. For example, an AV conference graphical user interface may provide a list of participants in the AV conference, and the participants can manually select which other participants they are in close proximity to. In some cases, participants will only be recognized by the AV conferencing system as being in the same location if both participants have selected each other.

The AV conferencing system may select an initial or proposed selection of local participants (e.g., based on location information and/or proximity information as described above), and the participants can override or change the initial or proposed selection (e.g., if the AV conferencing system incorrectly identifies users as being local or remote). In some cases, the graphical user interface may display a representative map of the participants, showing which participants have been determined to be sharing a physical location, and which have been determined to be remote. Users may be able to drag and drop representations of the participants to correctly reflect their locations (or otherwise change the initial selections).

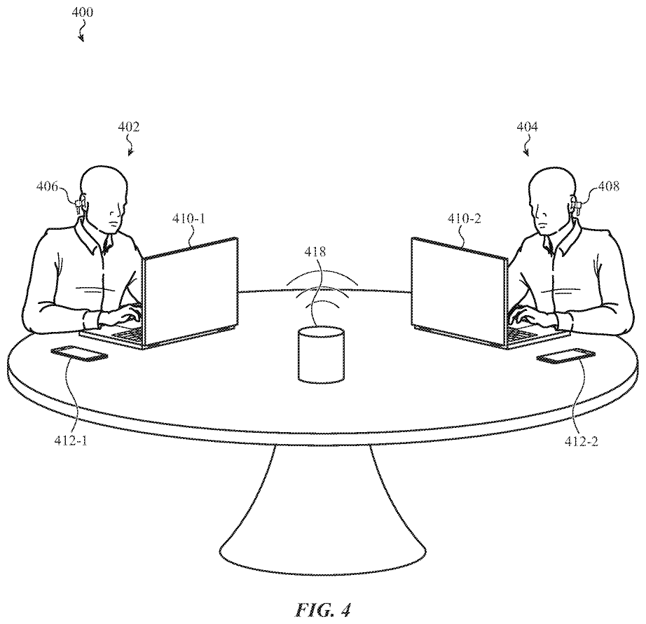

FIG. 4 illustrates an example shared physical space 400 with two local participants 402, 404, illustrating example wearable audio device and electronic devices that may be part of and/or interact with the AV conferencing system. The wearable audio devices 406, 408 of the local participants may be communicatively coupled to (and/or otherwise associated with) one or more electronic devices 410, 412 of the local participants, and the electronic devices may send and/or receive audio and video information of the local participants for the AV conference.

As shown, each local participant is using a wearable audio device 406, 408, which may be or may resemble ear buds and may be positioned at least partially in the ear of the participant. The wearable audio devices 406, 408 may include a microphone system that includes an array of microphones (e.g., at least one microphone per ear bud) and that performs beamforming operations to preferentially capture sound produced by the wearer. In this way, when the first local participant 402 speaks, the wearable audio device 408 of the second local participant 404 will not capture (or will capture less of) the first local participant's audio output. Accordingly, audio information from the first local participant's wearable audio device 406 can be expected to contain only (or primarily) audio output from the first local participant, and the audio output captured by that wearable audio device can be assigned to the participant associated with that wearable audio device (e.g., for the purpose of indicating which local participant is speaking at a given time).

The wearable audio devices 406, 408 may also include a pass-through audio mode in which local audio may be captured by the wearable audio devices 406, 408 and reproduced to the wearer. The pass-through audio mode may allow each local participant to hear the other local participants by mitigating the muting or attenuation effects that the wearable audio devices 406, 408 may otherwise produce (e.g., due to being positioned in the wearers' ears). In some cases, the audio processing for the pass-through audio mode may be executed outside the AV conferencing system (e.g., by the wearable audio devices 406, 408 and without relying on audio processing by other devices and/or within the AV conferencing system operations). When a pass-through audio mode is being used, an audio feed of the AV conference may also be provided to the participant. Thus, a participant can hear other local participants via the pass-through audio, and can hear the remote participants via the aggregate audio feed.

The wearable audio devices 406, 408 may also include passive noise cancellation (e.g., muting and/or sound attenuation due to physically blocking or plugging ears) and/or active noise cancellation functionality (e.g., processing received ambient audio and actively cancelling, muting, and/or attenuating some or all of the received ambient audio).

As shown in FIG. 4, participants may use and/or be associated with one or more electronic devices, all or some of which may be used to determine which users are sharing a physical space. For example, as shown in FIG. 4, each participant is associated with a first electronic device 410 and a second electronic device 412 (though each participant may be associated with more or fewer electronic devices). The electronic devices 410, 412 for each participant may be associated with a common user account or identifier, such that information from any device associated with a participant can be used to determine location information for that participant. For example, the first electronic device 410-1 of the first participant 402 may interact with the second electronic device 412-2 of the second participant 404 to determine whether a location criteria is satisfied (e.g., that they are within a threshold distance and therefore likely in a shared physical space). As another example, the geographical locations of the participants as determined by the second electronic devices 412 may be evaluated by the AV conferencing system to determine whether the location criteria is satisfied. As another example, the second electronic devices 412 may emit audio signals that may be detected by the wearable audio devices 406, 408 to determine if the participants are in a shared physical space. Other techniques are also possible.

The electronic devices may also provide audio and/or video information of the participant to other components of the AV conferencing system. For example, audio information from a local participant's wearable audio device may be transmitted to a first electronic device 410 and/or a second electronic device 412, which may then send the audio information to an audio feed aggregation service. Similarly, video information of a user may be captured by a first electronic device 410 and/or a second electronic device 412, which may then send the video information to a video feed service of the AV conferencing system.

The electronic devices 410, 412 may execute one or more application programs that interact with and/or act as part of the AV conferencing system. For example, when joining an AV conference, a user may initiate a connection to a particular AV conference via an application program on one or more of the electronic devices. In some cases, an electronic device that is associated with a given participant (e.g., linked to a common user account) may provide information to the AV conferencing system about the participant even if the user is not actively using that device to connect to an AV conference. For example, the first local participant 402 may join an AV conference via the first electronic device 410-1, while location information about the first local participant 402 may be determined at least in part based on information from the second electronic device 412-2.

As shown in FIG. 4, a shared physical space may be associated with one or more conference audio devices, such as the conference audio device 418. The conference audio device 418 may include one or more speakers and one or more microphones. The conference audio device 418 may be used to capture audio information from and provide aggregate audio output to participants who are in the shared physical space but do not have dedicated audio devices (e.g., a participant who is not connecting to the AV conference via an electronic device). The conference audio device 418 may include an array of microphones and may perform a beamforming operation to differentiate between audio outputs of different participants in the shared physical space 400. In some cases, the participants whose audio output is captured by the conference audio device 418 may be associated with a name or identifier (e.g., manually by a user or automatically), such that the AV conferencing system can uniquely identify that participant when they are speaking in the shared space, even without a dedicated audio capture device.

The conference audio device 418 also includes one or more speakers that may output an aggregate audio feed for an AV conference. For example, when there are local participants in the shared physical space who are using the conference audio device 418 for audio connection to the AV conference, the conference audio device 418 may output the aggregate local audio feed for that location via the speakers. In such cases, wearable audio devices of other local participants may operate in a pass-through audio mode and may receive no aggregate audio feed (or may otherwise not output the aggregate audio feed to the participant) to avoid duplicate and/or overlapping audio. As another example, the wearable audio devices of other local participants may operate in a noise-cancelling or sound-blocking mode, and a full aggregate audio feed (e.g., including audio information from all participants except the receiving participant) may be provided to the participant. In some cases, each participant with a wearable audio device can select whether to operate in the pass-through or the sound-blocking mode when they are in a shared space with participants who are using a conference audio device (or otherwise do not have a personal, wearable audio device to receive conference audio feeds).

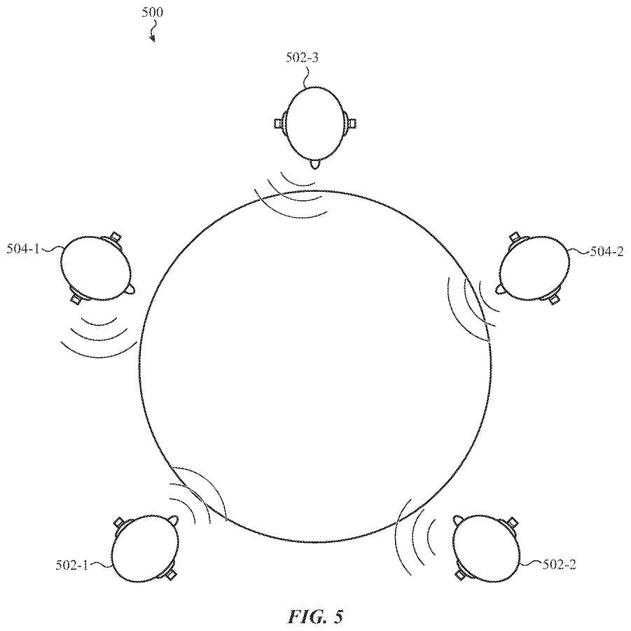

In some cases, wearable audio devices may include sensing systems that can determine a position of a wearer's head, and audio output systems that can cause audio output to change based on the position of the wearer's head, and/or cause the audio output to appear to originate at a particular location. In such cases, audio from remote participants in an AV conference may be provided to a local participant such that their audio seems, to the local participant, to be coming from a particular location in the shared physical space. FIG. 5 illustrates an example shared physical space 500 that includes three local participants 502-1-502-3. FIG. 5 illustrates the perceived location of various audio sources from the perspective of the first local participant 502-1. For example, the first local participant 502-1 may perceive the audio source location of each other local participant based on their actual location.

The wearable audio devices may output audio from remote participants such that the perceived audio source location for respective remote participants is at different respective locations in the shared physical space. Thus, for example, audio information from a first remote participant 504-1 may sound, to the first local participant 502-1, like it is originating from a particular location in the shared physical space (e.g., to the left of the first local participant 502-1, as illustrated in FIG. 5). Similarly, audio information from a second remote participant 504-2 may sound, to the first local participant 502-1, like it is originating from a different location in the shared physical space (e.g., generally across from the first local participant 502-1, as illustrated in FIG. 5). Thus, the first local participant will perceive the audio from the remote participants to be originating at different, unique locations in the shared physical space 500. The perception of unique locations of remote participants may be produced using stereo effects, such as by providing different audio output volumes to each ear of a listener, and/or changing the audio output volumes in each ear as the listener's head moves.

Moreover, because the wearable audio devices can determine the position of the wearer's head and/or body, when the listener's head moves, the perceived location of the remote participants may remain the same. Thus, for example, the audio information from the first remote participant 504-1 may sound, to the first local participant 502-1, as though it is originating at the same location in the shared space regardless of the position or orientation oft eh local participant's head. Stated another way, aspects of the audio that is outputted to the first local participant 502-1 may change in accordance with the local participant's head movements so that the audio from the remote participants appear to have a fixed location in the shared space.

In some cases, the virtual location of remote participants may be the same for all local participants. Thus, for example, the audio presented to each local participant may be configured so that the first remote participant 504-1 is between the first and third local participants 502-1 and 502-3, and the second remote participant 504-2 is between the second and the third local participants 502-2, 502-3. In some cases, location and/or proximity information from the devices associated with the local participants may be used to generate a local participant map, and remote participants may be virtually located in the shared physical space using the map. In this way, each local participant can perceive a remote participant in the same virtual location.

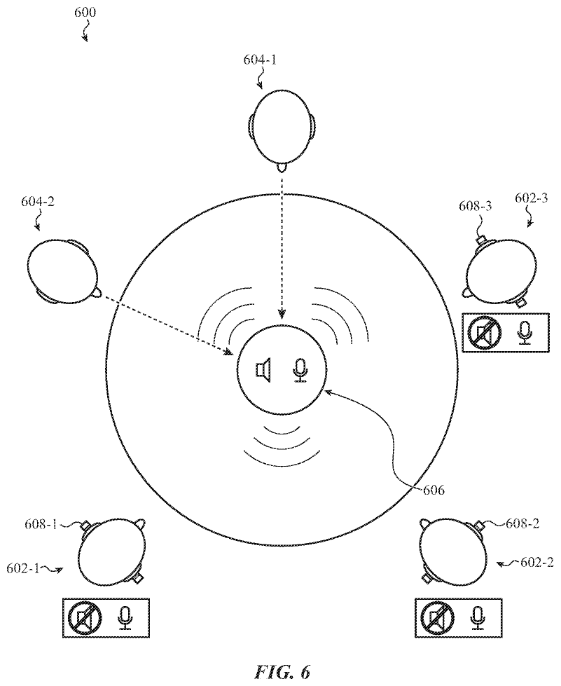

As described herein, shared physical spaces may be shared by participants who are using wearable audio devices or otherwise associated with an audio capture device that is uniquely associated an account of the participant (or is otherwise able to associate audio output from a single participant with an identifier of that participant), as well as participants that do not have such devices and are instead using a conference audio device. FIG. 6 illustrates an example shared physical space 600 with both types of participants.

As shown in FIG. 6, the shared physical space 600 may include first participants 602 and second participants 604. The first participants 602 are each associated with a wearable audio device 608 (or other audio device that is able to associate audio output from a single participant with an identifier of that participant), and the second participants 604 are interacting with an AV conference via a shared conference audio device 606. The wearable audio devices 608 may send captured audio information to the AV conferencing system via another electronic device associated with the wearer, as described herein. In some cases, the wearable audio devices 608 may send captured audio information to the AV conferencing via the conference audio device 606.

As described herein, under these circumstances, the particular modes of audio capture and audio production for the various devices may be selected to provide a good user experience for all participants. For example, because each participant in the shared physical space can hear each other directly, and because the second participants are relying on a speakerphone (e.g., speakers of the shared conference audio device 606) to hear the audio of the AV conference, the wearable audio devices 608 operate in a speaker mute mode (as indicated by the muted speaker icons for each first participant 602), in which no audio is produced for the wearer. Rather, the first participants 602 hear the AV conference audio from remote participants via the shared conference audio device 606, and from the second participants 604 directly. In some cases, the wearable audio devices 608 operate in a pass-through audio mode such that the audio from the second participants 604 and from the conference audio device 606 is reproduced to the wearer. Under these circumstances, the wearable audio devices 608 still capture audio information from the first participants 602 (as indicated by the microphone icons for each first participant 602), such that audio information captured by those devices can be associated with the identity of the wearer.

The shared conference audio device 606 may provide both audio capture and audio output functions. In particular, the conference audio device 606 may produce an audio output corresponding to an aggregate audio feed that includes audio information from all participants who are not in the shared physical space 600, and excluded audio information from all participants in the shared physical space 600. Thus, for example, the aggregate audio feed being presented by the conference audio device 606 may exclude audio information captured by the conference audio device 606, and audio information captured by the wearable audio devices 608 of the first participants 602.

As noted above, the AV conferencing system may determine that a shared physical space is being shared by participants using wearable audio device and participants using a conference audio device, and select and/or generate aggregate audio feeds and/or select operational modes of the wearable audio devices and conference audio device accordingly. For example, the AV conferencing system may determine that the wearable audio devices 608 satisfy a location criteria with respect to the shared conference audio device 606 (e.g., based on location information of electronic devices of the first participants 602 and location information of the shared conference audio device 606), and, in response to the determination, select particular operational modes for the wearable audio devices 608 and the conference audio device 606. Further, the AV conferencing system may select and/or generate the proper aggregate audio feed to be produced by the shared conference audio device 606. For example, based on the wearable audio devices 608 satisfying the location criteria with respect to the conference audio device 606 (e.g., the conference audio device and the wearable devices being within a threshold distance or otherwise sharing a same physical space), the AV conferencing system may generate an aggregate audio feed that includes audio information from all other participants, while excluding the audio information captured by the conference audio device 606 and by each of the wearable audio devices 608 in the shared physical space 600.

In a conventional AV conferencing system, this type of combination of participants in a shared physical space (e.g., some using dedicated wearable audio devices and some relying on a shared conference audio device 606) may not be effective, as the shared conference audio device 606 may output the audio information captured by the wearable audio devices 608 of the first participants 602, thereby causing duplicate, overlapping, or otherwise distracting audio (as each participant in the shared physical space may hear the first participants' voices twice). The instant system, however, customizes the way that audio is presented to the participants such that the combination of different audio capture and presentation methodologies is practicable.

In some cases, the users with wearable audio devices may automatically connect to and/or disconnect from an AV conference based on proximity to a local space with an active AV conference. In particular, wearable audio devices may be uniquely associated with users. For example, a unique identifier of a wearable audio device (e.g., a serial number) may be associated with a user account of an individual. Further, the wearable audio devices may be capable of communicatively coupling to various different devices to send and/or receive audio. For example, a wearable audio device may wirelessly couple to a conference audio device (e.g., via Bluetooth or another suitable wireless communication technique) to provide captured audio to the AV conferencing system and receive audio from the AV conferencing system. In some cases, the wearable audio devices may also include sensors that determine whether or not the wearable audio devices are being worn (e.g., whether or not they are positioned at least partially in the ear of a user). These features of the wearable audio devices and AV conferencing system more generally may be used to automatically connect and/or disconnect a wearable audio device to an AV conference. For example, when a wearable audio device detects that it is being worn (e.g., it detects that it is at least partially in an ear of a wearer), the wearable audio device may attempt to connect to nearby devices that may be associated with an active or upcoming AV conference (e.g., conference audio devices, the wearer's or another participant's electronic device). The AV conferencing system may determine if any attempted connections from wearable audio devices are associated with an invitee to an active or upcoming AV conference (e.g., by comparing an identifier of a device that is attempting to connect to an AV conference to device identifiers associated with the user accounts of the invitees). If the AV conferencing system determines a match, the wearable audio device may be connected to the AV conference via a nearby device, and an appropriate aggregate audio feed may be provided to the wearable audio device. Thus, for example, if a participant arrives to a shared physical space while an AV conference is ongoing (and if that participant is an invitee to the AV conference), the participant may simply begin wearing his or her wearable audio device. If the AV conferencing system determines that the participant is an invitee, the participant may be automatically connected to the AV conference via the wearable audio device.

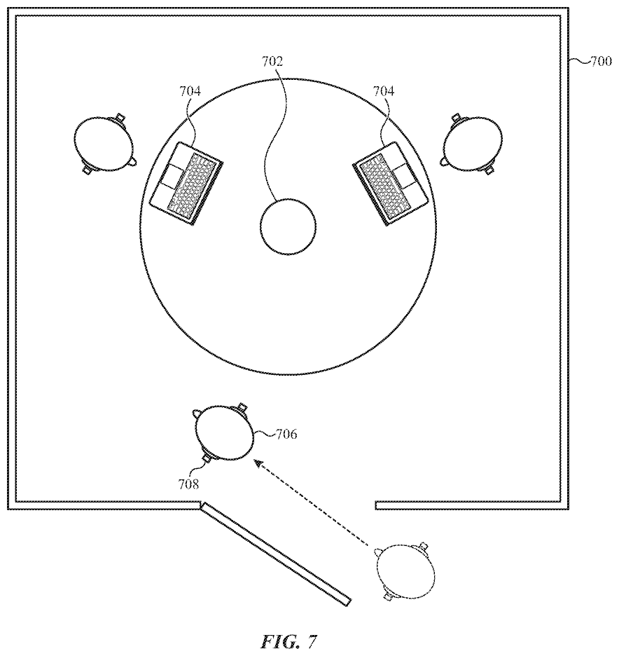

FIG. 7 illustrates an example of how a participant may be automatically joined to an AV conference based on the participant entering a shared physical space 700. For example, a participant 706 may enter the shared physical space 700 while wearing a wearable audio device 708 (or may begin wearing the wearable audio device 708 after entering the shared physical space 700. Upon entering, the wearable audio device 708 may attempt to connect to a device that is communicatively coupled to the AV conferencing system, such as devices 704 associated with other participants, a conference audio device 702, or an electronic device associated with the participant 706. Additionally, location information of the wearable audio device may also be determined (which may include one or more of the devices 702, 704, and/or a device associated with the participant 706 determining a location and/or a proximity of the wearable audio device). If the participant 706 is an invitee of the AV conference, the wearable audio device 708 is being worn, and the location criteria is satisfied (e.g., the participant 706 has entered or is in the shared physical space), the AV conferencing system may begin receiving captured audio from the wearable audio device 708 and sending an appropriate aggregate audio feed to the wearable audio device 708 (e.g., an aggregate audio feed that includes audio from remote participants and excludes audio from local participants in the shared physical space 700.

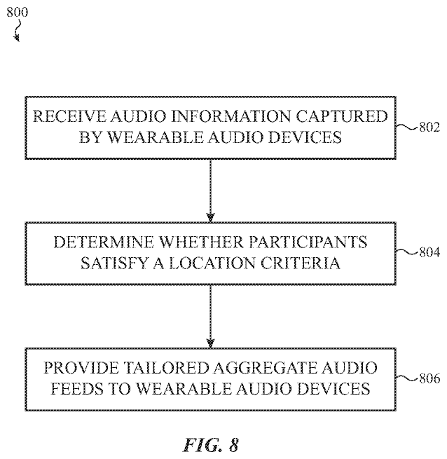

FIG. 8 is a flow chart illustrating an example method 800 for providing aggregate audio feed to wearable audio devices. At operation 802, audio information captured by wearable audio devices is received, where the wearable audio devices are associated with participants of an AV conference. The audio information may be captured by one or more microphones of the wearable audio devices, as described herein.

At operation 804, it is determined whether the participants from which the audio information is captured satisfy a location criteria (and/or which participants satisfy a location criteria). The location criteria may be satisfied if it is determined that the participants are likely to be sharing a physical space. As one example, the location criteria may be satisfied if the participants are within a threshold distance of one another. As another example, the location criteria may be satisfied if multiple wearable electronic devices are capturing the same or overlapping audio information (e.g., if two different wearable audio devices are determined to be capturing the same or overlapping audio information, it can be deduced that they are in the same shared physical space).

At operation 806, aggregate audio feeds that are tailored for each wearable audio device sharing a physical space are provided to the wearable audio devices. For example, each wearable audio device that is in a shared physical space with other wearable audio devices may be provided with an aggregate audio feed that includes audio information from each remote participant (and any other local participants in different shared physical spaces), and excludes audio information from each local participant in the same physical space (e.g., from their wearable audio devices). As another example, each wearable audio device that is in a shared physical space with other wearable audio devices and with a shared conference audio device may be provided with an aggregate audio feed that includes audio information from each remote participant (and any other local participants in different shared physical spaces), and excludes audio information captured by the shared conference audio device and from other local participants in the same physical space (e.g., from their wearable audio devices).

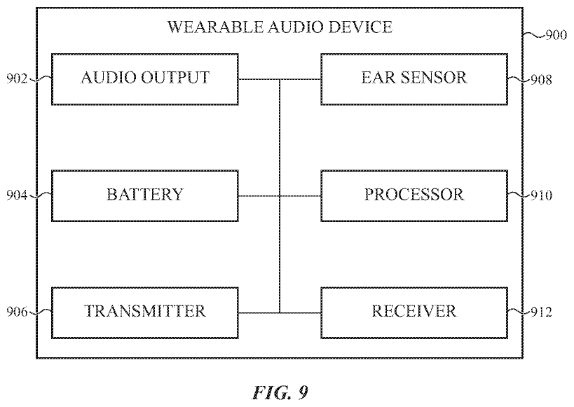

FIG. 9 depicts components of a sample wearable audio device 900. The wearable audio device 900 may correspond to and/or be an embodiment of the wearable audio devices 118, or other wearable audio devices described herein. It will be appreciated that the components are illustrative and not exhaustive. Further, some embodiments may omit one or more of the depicted components or may combine multiple depicted components. The wearable audio device 900 may include an audio output structure 902, an ear sensor 908, a transmitter 906, a receiver 912, a battery 904, and/or a processing unit or processor 910, as well as other elements common to electronic devices, such as a touch- or force-sensitive input structure, visual output structure (e.g., a light, display, or the like), an environmental audio sensor, and so on. Each depicted element will be discussed in turn.

The audio output structure 902 may be a speaker or similar structure that outputs audio to a user's ear. If the wearable audio device 900 is a pair of headphones, there are two audio output structures 902, one for each ear. If the wearable audio device 900 is a single earbud, then there is a single audio output structure 902. In the latter case, each earbud may be considered a separate wearable audio device 900 and thus two wearable audio devices may be used by, or included in, certain embodiments. The audio output structure 902 may play audio (e.g., aggregate audio feeds, among other possible audio) at various levels; the audio output level may be controlled by the processor 910, as one example.

The ear sensor 908 may be any type of sensor configured to receive or generate data indicating whether the wearable audio device 900 is on, adjacent, and/or at least partially in a user's ear (generally, positioned to output audio to the user's ear). In some embodiments, the wearable audio device 900 may have a single ear sensor 908 configured to provide data regarding whether a single or particular audio output structure 902 is positioned to output audio to the user's ear. In other embodiments, the wearable audio device 900 may have multiple ear sensors 908 each configured to detect the position of a unique audio output structure 902 (for example, where the wearable audio device is a pair of headphones). Sample ear sensors include capacitive sensors, optical sensors, resistive sensors, thermal sensors, audio sensors, pressure sensors, and so on.

The wearable audio device 900 may include a transmitter 906 and a receiver 912. In some embodiments, the transmitter 906 and the receiver 912 may be combined into a transceiver. Generally, the transmitter 906 enables wireless or wired data transmission to another electronic device (e.g., a phone, laptop computer, tablet computer, desktop computer, shared conference audio device, etc.) while the receiver 912 enables wireless or wired data receipt from the other electronic device. The transmitter 906 and the receiver 912 (or transceiver) may facilitate communication with other electronic devices as well, whether wired or wirelessly. Examples of wireless communication include radio frequency, Bluetooth, infrared, and Bluetooth low energy communication, as well as any other suitable wireless communication protocol and/or frequency.

The wearable audio device 900 may also include a battery 904 configured to store power. The battery 904 may provide power to any or all of the other components discussed herein with respect to FIG. 9. The battery 904 may be charged from an external power source, such as a power outlet, a charging cable, a charging case, or the like. The battery 904 may include, or be connected to, circuitry to regulate power drawn by the other components of the wearable audio device 900.

The wearable audio device 900 may also include a processor 910. In some embodiments, the processor 910 may control operation of any or all of the other components of the wearable audio device 900. The processor 910 may also receive data from the receiver 912 and transmit data through the transmitter 906, for example, from and/or to other electronic devices as described herein. The processor 910 may thus coordinate operations of the wearable audio device 900 with other electronic devices of an AV conferencing system or that interface with an AV conferencing. The processor 910, although referred to in the singular, may include multiple processing cores, units, chips, or the like. For example, the processor 910 may include a main processor and an audio processor.

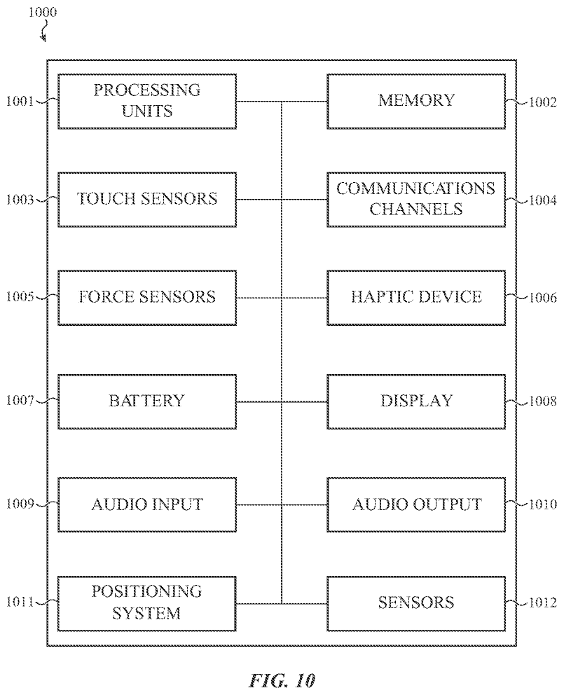

FIG. 10 depicts an example schematic diagram of an electronic device 1000. The electronic device 1000 may be an embodiment of or otherwise represent electronic devices that are used by and/or are part of an AV conferencing system as described herein. For example, the electronic devices 1000 may be an embodiment of or otherwise represent the electronic devices 106, the AV conferencing system server 102, the shared conference audio device 115, or other electronic devices described herein. The device 1000 includes one or more processing units 1001 that are configured to access a memory 1002 having instructions stored thereon. The instructions or computer programs may be configured to perform one or more of the operations or functions described with respect to the electronic devices described herein. For example, the instructions may be configured to control or coordinate the operation of one or more displays 1008, one or more touch sensors 1003, one or more force sensors 1005, one or more communication channels 1004, one or more audio input systems 1009, one or more audio output systems 1010, one or more positioning systems 1011, one or more sensors 1012, and/or one or more haptic feedback devices 1006.

The processing units 1001 of FIG. 10 may be implemented as any electronic device capable of processing, receiving, or transmitting data or instructions. For example, the processing units 1001 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 1002 can store electronic data that can be used by the device 1000. For example, a memory can store electrical data or content such as, for example, audio and video files, images, documents and applications, device settings and user preferences, programs, instructions, timing and control signals or data for the various modules, data structures or databases, and so on. The memory 1002 can be configured as any type of memory. By way of example only, the memory can be implemented as random access memory, read-only memory, Flash memory, removable memory, or other types of storage elements, or combinations of such devices.

The one or more communication channels 1004 may include one or more wireless interface(s) that are adapted to provide communication between the processing unit(s) 1001 and an external device. For example, the one or more wireless interface(s) may provide communication between the device 1000 and a wearable audio device (e.g., the wearable audio device 900 or any other wearable audio devices described herein). The one or more wireless interface(s) may also provide communication between the device 1000 and other devices, such as other instances of the device 1000. For example, the one or more wireless interface(s) may provide communication between multiple personal electronic devices associated with participants in an AV conference, or between a personal electronic device (e.g., a laptop computer, mobile phone, etc.) and a shared conference audio device, or between a personal electronic device and a remote AV conferencing server. Other communications may also be facilitated by the one or more communications channels 1004 to facilitate AV conferencing and/or other communications functions of an electronic device.

The one or more communication channels 1004 may include antennas, communications circuitry, firmware, software, or any other components or systems that facilitate wireless communications with other devices (e.g., with wearable audio devices, conference audio devices, other devices of the AV conferencing system, etc.). In general, the one or more communication channels 1004 may be configured to transmit and receive data and/or signals that may be interpreted by instructions executed on the processing units 1001. In some cases, the external device is part of an external communication network that is configured to exchange data with wireless devices. Generally, the wireless interface may communicate via, without limitation, radio frequency, optical, acoustic, and/or magnetic signals and may be configured to operate over a wireless interface or protocol. Example wireless interfaces include radio frequency cellular interfaces (e.g., 2G, 3G, 4G, 4G long-term evolution (LTE), 5G, GSM, CDMA, or the like), fiber optic interfaces, acoustic interfaces, Bluetooth interfaces, infrared interfaces, USB interfaces, Wi-Fi interfaces, TCP/IP interfaces, network communications interfaces, or any conventional communication interfaces. The one or more communications channels 1004 may also include ultra-wideband (UWB) interfaces, which may include any appropriate communications circuitry, instructions, and number and position of suitable UWB antennas.

The touch sensors 1003 may detect various types of touch-based inputs and generate signals or data that are able to be accessed using processor instructions. The touch sensors 1003 may use any suitable components and may rely on any suitable phenomena to detect physical inputs. For example, the touch sensors 1003 may be capacitive touch sensors, resistive touch sensors, acoustic wave sensors, or the like. The touch sensors 1003 may include any suitable components for detecting touch-based inputs and generating signals or data that are able to be accessed using processor instructions, including electrodes (e.g., electrode layers), physical components (e.g., substrates, spacing layers, structural supports, compressible elements, etc.), processors, circuitry, firmware, and the like. The touch sensors 1003 may be integrated with or otherwise configured to detect touch inputs applied to any portion of the device 1000. For example, the touch sensors 1003 may be configured to detect touch inputs applied to any portion of the device 1000 that includes a display (and may be integrated with a display). The touch sensors 1003 may operate in conjunction with the force sensors 1005 to generate signals or data in response to touch inputs. A touch sensor or force sensor that is positioned over a display surface or otherwise integrated with a display may be referred to herein as a touch-sensitive display, force-sensitive display, or touchscreen.

The force sensors 1005 may detect various types of force-based inputs and generate signals or data that are able to be accessed using processor instructions. The force sensors 1005 may use any suitable components and may rely on any suitable phenomena to detect physical inputs. For example, the force sensors 1005 may be strain-based sensors, piezoelectric-based sensors, piezoresistive-based sensors, capacitive sensors, resistive sensors, or the like. The force sensors 1005 may include any suitable components for detecting force-based inputs and generating signals or data that are able to be accessed using processor instructions, including electrodes (e.g., electrode layers), physical components (e.g., substrates, spacing layers, structural supports, compressible elements, etc.), processors, circuitry, firmware, and the like. The force sensors 1005 may be used in conjunction with various input mechanisms to detect various types of inputs. For example, the force sensors 1005 may be used to detect presses or other force inputs that satisfy a force threshold (which may represent a more forceful input than is typical for a standard “touch” input). Like the touch sensors 1003, the force sensors 1005 may be integrated with or otherwise configured to detect force inputs applied to any portion of the device 1000. For example, the force sensors 1005 may be configured to detect force inputs applied to any portion of the device 1000 that includes a display (and may be integrated with a display). The force sensors 1005 may operate in conjunction with the touch sensors 1003 to generate signals or data in response to touch- and/or force-based inputs.

The device 1000 may also include one or more haptic devices 1006. The haptic device 1006 may include one or more of a variety of haptic technologies such as, but not necessarily limited to, rotational haptic devices, linear actuators, piezoelectric devices, vibration elements, and so on. In general, the haptic device 1006 may be configured to provide punctuated and distinct feedback to a user of the device. More particularly, the haptic device 1006 may be adapted to produce a knock or tap sensation and/or a vibration sensation. Such haptic outputs may be provided in response to detection of touch and/or force inputs, and may be imparted to a user through the exterior surface of the device 1000 (e.g., via a glass or other surface that acts as a touch- and/or force-sensitive display or surface).

As shown in FIG. 10, the device 1000 may include a battery 1007 that is used to store and provide power to the other components of the device 1000. The battery 1007 may be a rechargeable power supply that is configured to provide power to the device 1000. The battery 1007 may be coupled to charging systems (e.g., wired and/or wireless charging systems) and/or other circuitry to control the electrical power provided to the battery 1007 and to control the electrical power provided from the battery 1007 to the device 1000.

The device 1000 may also include one or more displays 1008 configured to display graphical outputs. The displays 1008 may use any suitable display technology, including liquid crystal displays (LCD), organic light emitting diodes (OLED), active-matrix organic light-emitting diode displays (AMOLED), or the like. The displays 1008 may display graphical user interfaces, images, icons, or any other suitable graphical outputs.

The device 1000 may also provide audio input functionality via one or more audio input systems 1009. The audio input systems 1009 may include microphones, transducers, or other devices that capture sound for voice calls, video calls, audio recordings, video recordings, voice commands, and the like. The audio input systems 1009 may include an array of microphones, and may be configured to perform beamforming operations to preferentially capture audio from a particular user.

The device 1000 may also provide audio output functionality via one or more audio output systems (e.g., speakers) 1010. The audio output systems 1010 may produce sound from AV conferences, voice calls, video calls, streaming or local audio content, streaming or local video content, or the like.

The device 1000 may also include a positioning system 1011. The positioning system 1011 may be configured to determine the location of the device 1000. For example, the positioning system 1011 may include magnetometers, gyroscopes, accelerometers, optical sensors, cameras, global positioning system (GPS) receivers, inertial positioning systems, or the like. The positioning system 1011 may be used to determine spatial parameters of the device 1000, such as the location of the device 1000 (e.g., geographical coordinates of the device), measurements or estimates of physical movement of the device 1000, an orientation of the device 1000, or the like. The positioning system 1011 may also be configured to determine a location of and/or a proximity to a wearable audio device and/or other electronic devices. This information may be used by the device 1000 and/or other devices or services of an AV conferencing system to determine whether a wearable audio device (or other electronic device) satisfies a location criteria indicating that it is likely in a same physical space as another wearable audio device.

The device 1000 may also include one or more additional sensors 1012 to receive inputs (e.g., from a user or another computer, device, system, network, etc.) or to detect any suitable property or parameter of the device, the environment surrounding the device, people, or things interacting with the device (or nearby the device), or the like. For example, a device may include temperature sensors, biometric sensors (e.g., fingerprint sensors, photoplethysmographs, blood-oxygen sensors, blood sugar sensors, or the like), eye-tracking sensors, retinal scanners, humidity sensors, buttons, switches, lid-closure sensors, or the like.

To the extent that multiple functionalities, operations, and structures described with reference to FIG. 10 are disclosed as being part of, incorporated into, or performed by the device 1000, it should be understood that various embodiments may omit any or all such described functionalities, operations, and structures. Thus, different embodiments of the device 1000 may have some, none, or all of the various capabilities, apparatuses, physical features, modes, and operating parameters discussed herein. Further, the systems included in the device 1000 are not exclusive, and the device 1000 may include alternative or additional systems, components, modules, programs, instructions, or the like, that may be necessary or useful to perform the functions described herein.

As described above, one aspect of the present technology is the gathering and use of data available from various sources to improve the usefulness and functionality of devices such as mobile phones. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to locate devices, deliver targeted content that is of greater interest to the user, or the like. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. Also, when used herein to refer to positions of components, the terms above, below, over, under, left, or right (or other similar relative position terms), do not necessarily refer to an absolute position relative to an external reference, but instead refer to the relative position of components within the figure being referred to. Similarly, horizontal and vertical orientations may be understood as relative to the orientation of the components within the figure being referred to, unless an absolute horizontal or vertical orientation is indicated.

Features, structures, configurations, components, techniques, etc. shown or described with respect to any given figure (or otherwise described in the application) may be used with features, structures, configurations, components, techniques, etc. described with respect to other figures. For example, any given figure of the instant application should not be understood to be limited to only those features, structures, configurations, components, techniques, etc. shown in that particular figure. Similarly, features, structures, configurations, components, techniques, etc. shown only in different figures may be used or implemented together. Further, features, structures, configurations, components, techniques, etc. that are shown or described together may be implemented separately and/or combined with other features, structures, configurations, components, techniques, etc. from other figures or portions of the instant specification. Further, for ease of illustration and explanation, figures of the instant application may depict certain components and/or sub-assemblies in isolation from other components and/or sub-assemblies of an electronic device, though it will be understood that components and sub-assemblies that are illustrated in isolation may in some cases be considered different portions of a single electronic device (e.g., a single embodiment that includes multiple of the illustrated components and/or sub-assemblies).

1. A method comprising:
at an audiovisual conferencing system:
receiving first audio information captured by a first audio device associated with a first local participant of a group of local participants sharing a physical space during an audiovisual conference;
receiving second audio information captured by a second audio device associated with a second local participant of the group of local participants;
receiving third audio information from a remote participant; and
in accordance with a determination that the first local participant satisfies a location criteria during the audiovisual conference:
providing a first audio feed to the first audio device of the first local participant that includes the third audio information from the remote participant and omits the second audio information from the second local participant; and
providing a second audio feed to the second audio device of the second local participant that includes the third audio information from the remote participant and omits the first audio information from the first local participant; and
at the first audio device, the first audio device comprising a speaker, a microphone, and a processor and configured to be positioned at least partially in an ear of the first local participant, operating the first audio device in a pass-through audio mode, including:
capturing, with the microphone, local audio including audio from the first local participant and the second local participant;
locally processing, with the processor, the local audio to produce a pass-through audio feed; and
causing the speaker to output the first audio feed and the pass-through audio feed to the first local participant.

2. The method of claim 1, further comprising:
during the audiovisual conference, determining that the first local participant is speaking based at least in part on the first audio information; and
in accordance with the determination that the first local participant is speaking, providing an indication, in a graphical user interface of the remote participant, that the first local participant in the shared physical space is speaking.

3. The method of claim 1, wherein:
the first audio device is configured to send the first audio information to a first electronic device associated with the first local participant;
the second audio device is configured to send the second audio information to a second electronic device associated with the second local participant;
the first electronic device is configured to determine first location information of the first local participant;
the second electronic device is configured to determine second location information of the second local participant; and
the audiovisual conferencing system is configured to determine whether the first local participant satisfies a location criteria based at least in part on the first location information and the second location information.

4. The method of claim 1, wherein:
the first audio device is configured to send the first audio information to a first electronic device associated with the first local participant;
the second audio device is configured to send the second audio information to a second electronic device associated with the second local participant;
the first electronic device is configured to detect a distance between the first electronic device and the second electronic device; and
the location criteria is satisfied when the first electronic device is within a threshold distance of the second electronic device.

5. (canceled)

6. The method of claim 1, wherein:
the microphone is a first microphone;
the speaker is a first speaker;
the processor is a first processor;
the pass-through audio feed is a first pass-through audio feed;
the second audio device comprises:
a second speaker;
a second microphone; and
a second processor;
the second audio device is configured to be positioned at least partially in an ear of the second local participant; and
the method further comprises:
operating the second audio device in the pass-through audio mode, including:
capturing, with the second microphone, the local audio;
locally processing, with the second processor, the local audio to produce a second pass-through audio feed; and
causing the second speaker to output the second audio feed and the second pass-through audio feed to the second local participant.

7. The method of claim 1, wherein:
the first audio device comprises:
a first microphone system comprising a first array of microphones and configured to preferentially capture sound from the first local participant, the first microphone system including the microphone; and
the second audio device comprises:
a second microphone system comprising a second array of microphones and configured to preferentially capture sound from the second local participant.

8. The method of claim 7, wherein the first microphone system performs a beamforming operation to preferentially capture sound from the first local participant.

9. A method comprising, at an audiovisual conferencing system configured to host an audiovisual conference for a group of participants, the group of participants including a group of local participants sharing a physical space and a group of remote participants remote from the local participants:
receiving respective audio information from each respective local participant of at least a subset of the group of local participants, the respective audio information captured by respective wearable audio devices associated with the respective local participants;
receiving respective audio information from each respective remote participant of the group of remote participants;
providing a local audio feed to a wearable audio device of a local participant, the local audio feed:
including the audio information from each remote participant; and
excluding the audio information from each local participant; and
at the wearable audio device of the local participant:
capturing local audio from each local participant;
processing the local audio to produce a pass-through audio feed; and
outputting the pass-through audio feed to the local participant;
providing a remote audio feed to a remote participant, the remote audio feed:
including the audio information from each remote participant other than the remote participant; and
including the audio information from each local participant.

10. The method of claim 9, wherein:
the local audio feed is a first local audio feed;
the method further comprises providing a second local audio feed to a conference audio device positioned in the physical space and including a speaker and a microphone; and
the second local audio feed:
includes the audio information from each remote participant; and
excludes the audio information from each local participant.

11. The method of claim 10, wherein:
the subset of the group of local participants is a first subset of the group of local participants; and
the microphone of the conference audio device captures audio from a second subset of the group of local participants.

12. The method of claim 11, wherein:
the microphone is a first microphone;
the speaker is a first speaker; and
the wearable audio device of the local participant comprises:
a second microphone configured to capture audio from the local participant; and
a second speaker configured to output the first local audio feed to the local participant.

13. The method of claim 9, further comprising:
determining an identifier associated with a local participant of the subset of the group of local participants; and
in accordance with a determination that the local participant is speaking, causing an electronic device associated with a remote participant to display, in an audiovisual conferencing user interface, the identifier of the local participant.

14. The method of claim 13, wherein:
the electronic device is a first electronic device; and
the local participant is associated with a second electronic device;
the second electronic device receives audio information from the wearable audio device of the local participant; and
determining the identifier associated with the local participant comprises determining a user account associated with an audiovisual conferencing application executed by the second electronic device.

15. A method comprising:
at an audiovisual conferencing system:
for a group of participants in an audiovisual conference, the group of participants including at least one remote participant:
identifying a set of local participants of the group of participants who satisfy a location criteria with respect to each other, each respective local participant associated with a respective audio device;
providing, to the respective audio devices of the identified local participants, a local audio feed including audio information received from the remote participant; and
providing, to the remote participant, a remote audio feed including audio information received from each local participant; and
at a first audio device associated with a first local participant of the set of local participants:
capturing audio from a second local participant of the set of local participants;
processing the captured audio to produce a pass-through feed; and
outputting the pass-through audio feed to the first local participant.

16. The method of claim 15, wherein identifying the set of local participants who satisfy the location criteria with respect to each other comprises determining that a first local participant satisfies the location criteria with respect to a second local participant.

17. The method of claim 16, wherein determining that the first local participant satisfies the location criteria with respect to the second local participant comprises determining that the first local participant is in a same room as the second local participant.

18. The method of claim 16, wherein determining that the first local participant satisfies the location criteria with respect to the second local participant comprises determining that a first audio device associated with the first local participant detects audio also detected by a second audio device associated with the second local participant.

19. (canceled)

20. The method of claim 15, wherein:
the method further comprises providing, to a second audio device associated with a second local participant of the set of local participants, audio from the first local participant captured by a microphone of the second audio device.

21. The method of claim 15, wherein the first audio device is an earbud.

22. The method of claim 1, further comprising, in response to a request to transition from the pass-through audio mode to a sound-blocking mode:
performing local noise cancellation using the first audio device; and
providing a third audio feed to the first audio device, the third audio feed including the third audio information from the remote participant and the second audio information from the second local participant.
